(19) United States
(12) Patent Application Publication
(10) Pub. No.: US 2024/0152300 A1
(43) Pub. Date: May 9, 2024

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Ami KANZAKI, Kanagawa (JP); Naoto YAMASAKI, Kanagawa (JP)

(73) Assignee: FUJIFILM Business Innovation Corp., Tokyo (JP)

(21) Appl. No.: 18/296,517

(22) Filed: Apr. 6, 2023

(30) Foreign Application Priority Data
Nov. 9, 2022 (JP) 2022-179643

(51) Int. Cl. G06F 3/12

(52) U.S. Cl. CPC G06F 3/1208; G06F 3/1243

(57) ABSTRACT

An information processing apparatus includes a processor configured to switch, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.

### CROSS-REFERENCE TO RELATED APPLICATIONS

This application is based on and claims priority under 35 USC 119 from Japanese Patent Application No. 2022-179643 filed Nov. 9, 2022.

### BACKGROUND

### (i) Technical Field

The present disclosure relates to an information processing apparatus and a non-transitory computer readable medium.

### (ii) Related Art

Japanese Unexamined Patent Application Publication No. 2008-268575 discloses an imposition apparatus for creating an imposition template by placing at least one page and a mark on a printing plate or paper, including: a mark position information registration unit configured to register mark position information including variable information that changes depending on size information; a size information receiving unit configured to receive the size information; a mark position calculation unit configured to calculate a position of the mark by reflecting the received size information in the variable information included in the mark position information; and an imposition template creation unit configured to create the imposition template based on the calculated position of the mark.

Japanese Patent No. 6368690 discloses a workflow creation support apparatus for assisting in creation of a workflow for performing printing operations, including: a job information obtaining unit configured to obtain job information including information pertaining to a plurality of parameters that specify content of a job; a refinement processor configured to perform a refinement process of narrowing down a plurality of templates registered in advance to templates serving as selection candidates by using information of at least some parameters among the information pertaining to the plurality of parameters obtained by the job information obtaining unit; a selection screen data creation unit configured to create selection screen data used for displaying a selection screen that causes information of the templates narrowed down by the refinement processor to be displayed as selection candidates and that receives a selection operation for causing a user to select a single template from the selection candidates; and a job definition file creation unit configured to create a job definition file based on information of the single template selected through the selection operation and the information pertaining to the plurality of parameters, wherein the job information obtaining unit includes a file processor configured to perform a process of importing an electronic file of task instructions created by an external system and obtaining the job information from the electronic file of the task instructions.

For example, in the case of manufacturing make-to-order products with specifications that are different by customer, such as printed materials, the manufacturing process is also different for each make-to-order product. Therefore, at the manufacturing site of make-to-order products, a workflow representing the manufacturing process of each make-to-order product is created in advance, and, for each order, the workflow that matches the configuration of the make-to-order product is selected to manufacture the make-to-order product.

However, in order to manufacture such make-to-order products, it is necessary to create a workflow corresponding to each specification in advance, and some of the created workflows are used only once. Therefore, it is not always possible to achieve production efficiency commensurate with the labor required to create the workflow.

### SUMMARY

Aspects of non-limiting embodiments of the present disclosure relate to providing an information processing apparatus capable of manufacturing a make-to-order product without creating workflows corresponding to all make-to-order products in advance, and a non-transitory computer readable medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: switch, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.

### BRIEF DESCRIPTION OF THE DRAWINGS

Exemplary embodiments of the present disclosure will be described in detail based on the following figures, wherein:

FIG. 1 is a diagram illustrating an example of the configuration of a process management system;

FIG. 2 is a diagram illustrating an example of the configuration of an electric system of a process management apparatus;

FIG. 3 is a flowchart illustrating an example of the flow of an order receipt information creation process;

FIG. 4 is a diagram illustrating an example of an order receipt creation screen;

FIG. 5 is a diagram illustrating an example of a confirmation dialogue;

FIG. 6 is a flowchart illustrating an example of the flow of a template application process;

FIG. 7 is a diagram illustrating an example of an order receipt creation screen for a template usage mode;

FIG. 8 is a flowchart illustrating an example of the flow of a support process; and

FIG. 9 is a diagram illustrating an example of an order receipt creation screen in the support process.

### DETAILED DESCRIPTION

Hereinafter, exemplary embodiments of the disclosure will be described with reference to the drawings. Note that the same components and the same processes are given the same symbols throughout the drawings, and overlapping descriptions thereof are omitted.

### First Exemplary Embodiment

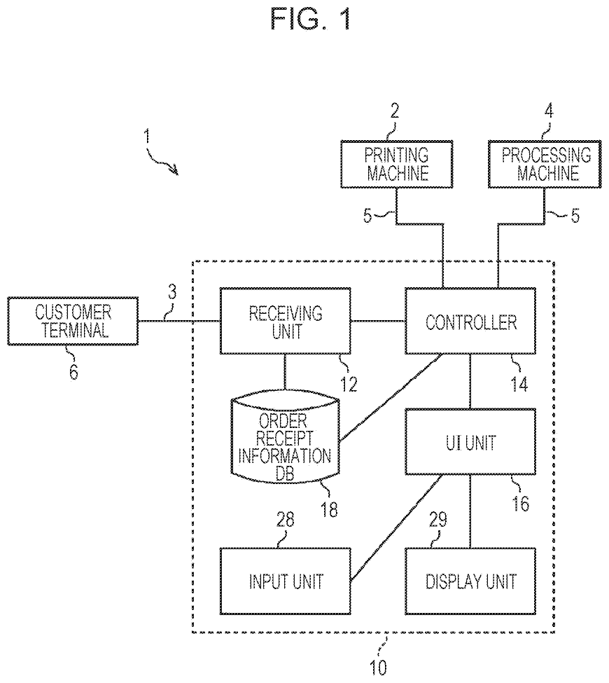

FIG. 1 is a diagram illustrating an example of the configuration of a process management system 1, which receives an order for a product from a customer terminal 6 operated by a customer and manages a manufacturing process of the product corresponding to the order received.

An order for a product received by the process management system 1 from the customer terminal 6 is an order for a make-to-order product. A make-to-order product is a product manufactured according to a specification specified by a customer. That is, a make-to-order product is a product whose specification is different by customer.

For example, automobiles are examples of make-to-order products because customers are able to freely choose the color of the body and the accessories. Furthermore, for example, molds used for manufacturing the parts are also manufactured in accordance with the shape of the parts desired by the customers, and thus they are also examples of make-to-order products. Moreover, printed materials such as books, brochures, and flyers are also examples of make-to-order products because the paper quality, size, color specification content, number of pages, binding method, number of copies, processing, and the like used are different by customer.

Although the process management system 1 manages the manufacturing process of make-to-order products in general as described above and manufactures make-to-order products, hereinafter, the process management system 1 will be described through an example of receiving an order for a printed material from the customer terminal 6 and manufacturing the ordered printed material.

The process management system 1 is introduced, for example, into a printing factory that manufactures printed materials ordered from customers. As illustrated in FIG. 1, the process management system 1 includes a printing machine 2, a processing machine 4, the customer terminal 6, and a process management apparatus 10.

The printing machine 2 is a device that prints specified characters, images, and the like onto recording media such as paper. There are no restrictions on the printing method of the printing machine 2, and any printing method, such as offset printing or digital printing, may be used.

The processing machine 4 is a device that performs post-processing such as folding, binding, and the like of the recording media printed by the printing machine 2. There are no restrictions on the type of processing performed by the processing machine 4, and the processing machine 4 performs processing corresponding to the processing content used in printing services provided to the customer.

The customer terminal 6 is a terminal operated by a customer who makes an order for a printed material, and the customer enters, in addition to customer information, which is information pertaining to the customer, such as the customer's name, identification (ID), and address, the specifications of the printed material ordered, such as specifying the number of copies of the printed material and the paper to be used.

The process management apparatus 10 operates the printing machine 2 and the processing machine 4 to manufacture a printed material in accordance with the content of an order received from the customer terminal 6, and manages the manufacturing process of the printed material. To do so, a person in charge at the printing factory (hereinafter simply referred to as “the person in charge”) creates configuration information of and a workflow for the printed material based on the content of the order received from the customer terminal 6, and saves them in the process management apparatus 10. The process management apparatus 10 operates the printing machine 2 and the processing machine 4 in accordance with the configuration information and the workflow created for each printed material, and thus manufactures the ordered printed material.

Configuration information of a printed material is information that defines the parts constituting the printed material. For example, if the printed material is a book, the book is generally divided into a cover and a text block. Like such a cover and a text block, the configuration units of the printed material that can be manufactured separately are called parts of the printed material.

Additionally, a workflow is information that represents the flow of the manufacturing process of a printed material by decomposing it into parts. For example, if the printed material is a book, the book is composed of a cover and a text block as described above, and accordingly, a schedule, such as what kind of printing machine 2 and processing machine 4 to use in what order and when, is set as a workflow for each cover and text block. In addition, a binding schedule for combining the manufactured cover and text block, and a schedule for dispatching the book after the binding has been completed are also set as the workflow.

The process management apparatus 10, which manages the manufacturing process of printed materials as described above, includes functional units including a receiving unit 12, a controller 14, and a user interface (UI) unit 16, and an order receipt information database (DB) 18, an input unit 28, and a display unit 29.

The receiving unit 12 receives an order for a printed material from the customer terminal 6, stores the content of the order, to which an order ID has been associated for each order, in the order receipt information DB 18, and notifies the controller 14 that there has been an order for a printed material.

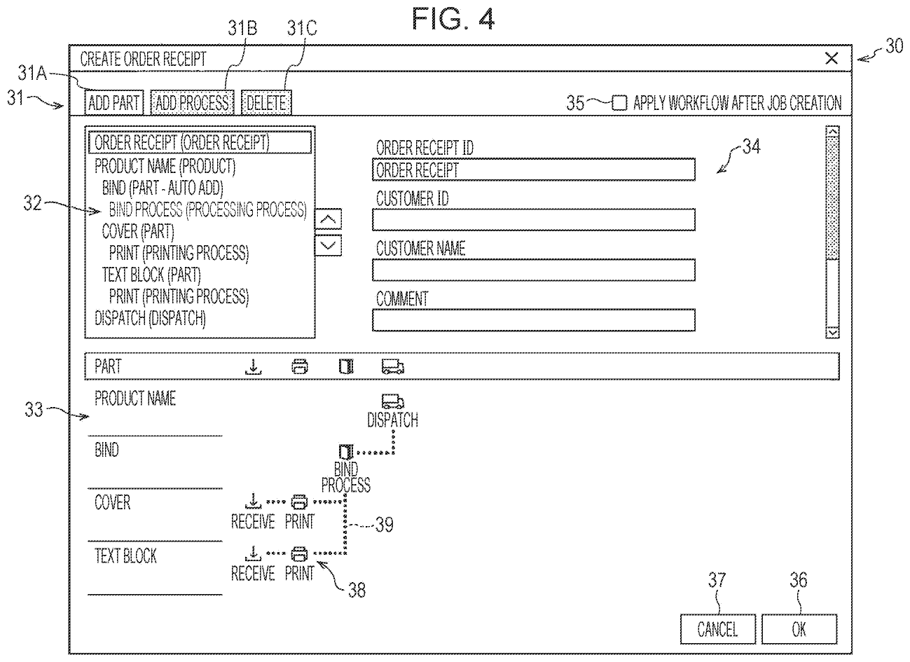

The controller 14 controls the UI unit 16 to display, on the display unit 29, an order receipt creation screen 30 (see FIG. 4; details will be described later) for allowing the person in charge to create configuration information of and a work flow for the ordered printed material. In addition, the controller 14 obtains the configuration information of and the workflow for the printed material entered by the person in charge through the order receipt creation screen 30 using the input unit 28 from the UI unit 16, associates the content of the order with the obtained configuration information of and the workflow for the printed material with each other, and stores them in the order receipt information DB 18 for each ordered printed material. Then, for each ordered printed material, the controller 14 performs control for operating the printing machine 2 and the processing machine 4 in accordance with the configuration information of and the workflow for the printed material, and managing the manufacturing process of the printed material.

In accordance with instructions of the controller 14, the UI unit 16 displays various screens including the order receipt creation screen 30 on the display unit 29, and notifies the controller 14 of the information entered on the screen displayed on the display unit 29 by the person in charge through the input unit 28. In other words, the UI unit 16 functions as an interface between the person in charge and the process management apparatus 10.

The input unit 28 is a device that receives instructions from the person in charge and notifies the UI unit 16 thereof, and, for example, buttons, a touchscreen, a keyboard, a pointing device, a mouse, etc. are used.

The display unit 29 is a device that displays a screen specified by the UI unit 16, and, for example, a liquid crystal display, an organic electroluminescence (EL) display, or the like is used.

For each ordered printed material, the order receipt information DB 18 stores the content of the order, the configuration information of the printed material, and the workflow in association with each other. Although the process management apparatus 10 of the present disclosure includes the order receipt information DB 18, the process management apparatus 10 need not necessarily include the order receipt information DB 18, and, for example, the order receipt information DB 18 may be provided in an external apparatus (not illustrated) connected to a communication line 3 or a communication line 5.

The process management apparatus 10 in the process management system 1 is configured using, for example, a computer 20.

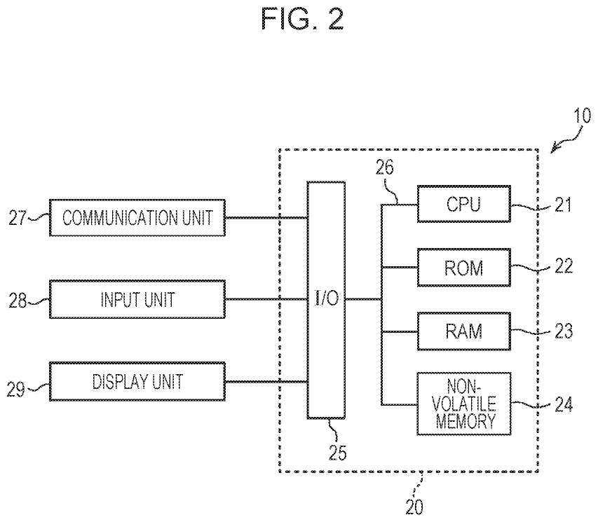

FIG. 2 is a diagram illustrating an example of the configuration of main portions of an electric system of the process management apparatus 10 using the computer 20.

The computer 20 includes a central processing unit (CPU) 21, which is an example of a processor responsible for the processing of each functional part illustrated in FIG. 1, a read-only memory (ROM) 22, which stores an activation program (basic input output system (BIOS)) for performing the activation processing of the computer 20, a random-access memory (RAM) 23, which is used as a temporary work area for the CPU 21, a non-volatile memory 24, and an input/output interface (I/O) 25. The CPU 21, the ROM 22, the RAM 23, the non-volatile memory 24, and the I/O 25 are connected to each other via a bus 26.

The non-volatile memory 24 is an example of a storage device in which the stored information is maintained even if the power supplied to the non-volatile memory 24 is cut off; and, for example, a semiconductor memory is used, but a hard disk may also be used. The non-volatile memory 24 stores parameters such as, for example, the connection destination information (for example, Internet Protocol (IP) address) of the printing machine 2 and the processing machine 4 connected to the process management apparatus 10 through the communication line 5. Also, as an example, the order receipt information DB 18 is formed in the non-volatile memory 24. Note that the non-volatile memory 24 need not necessarily be embedded in the computer 20, and may be a storage device attached to or detached from the computer 20, such as a memory card.

Meanwhile, a communication unit 27, the input unit 28, and the display unit 29 are connected to the I/O 25.

The communication unit 27 is connected to the communication line 3 and the communication line 5, and includes a communication protocol for data communication with various devices connected to the communication line 3 or the communication line 5, such as the printing machine 2, the processing machine 4, and the customer terminal 6.

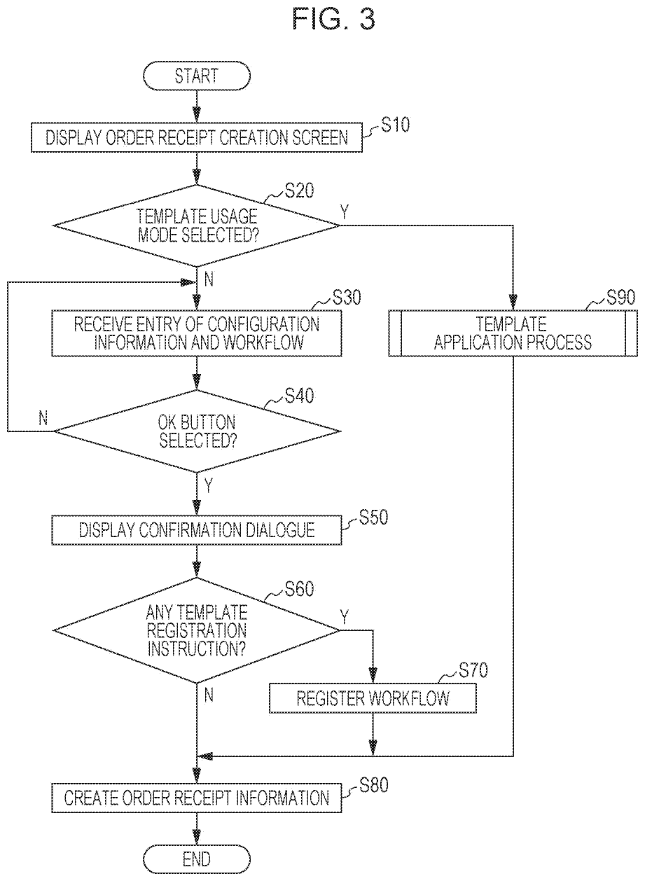

Next, the operation of the process management apparatus 10 will be described. FIG. 3 is a flowchart illustrating an example of the flow of an order receipt information creation process executed by the CPU 21 on receipt of, from the person in charge, a creation instruction for creating configuration information of and a workflow for a printed material ordered from a customer. An information processing program that defines the order receipt information creation process is stored in advance in, for example, the non-volatile memory 24 of the process management apparatus 10. The CPU 21 of the process management apparatus 10 reads the information processing program stored in the non-volatile memory 24 and executes the order receipt information creation process.

Note that, in the example of the present disclosure, a printed material for which configuration information and a workflow are to be created in response to a creation instruction from the person in charge is an example of a newly-ordered make-to-order product.

In step S10, the CPU 21 controls the display unit 29 and displays the order receipt creation screen 30 on the display unit 29.

FIG. 4 is a diagram illustrating an example of the order receipt creation screen 30. In the order receipt creation screen 30, customer information of the customer who has placed an order for the printed material is set in a customer information registration area 34 based on the content of the order stored in the non-volatile memory 24. The CPU 21 accepts editing done by the person in charge to the customer information displayed in the customer information registration area 34.

In the order receipt creation screen 30, a configuration information editing area 32 is an area for creating the configuration information of the printed material. To add the parts according to the order to the configuration information of the printed material, the person in charge selects a part addition button 31A among selection buttons 31. By selecting the part addition button 31A, a new part is added to the configuration information editing area 32, and thus the person in charge sets the name of the part according to the specification of the printed material.

Then, the person in charge sets, for each part, task contents for manufacturing the part (hereinafter referred to as “processes”). For example, task contents such as printing, processing, and dispatching are examples of processes. To set a process to a part, the person in charge selects a process addition button 31B among the selection buttons 31. By selecting the process addition button 31B, a new process is added to a specified part, and thus the person in charge specifies a process to implement according to the specification of the printed material.

To delete a part or a process displayed in the configuration information editing area 32, the person in charge simply selects a deletion button 31C with the part or process that the person in charge wishes to delete selected.

When the configuration information of the printed material is set in this manner, the names of the parts included in the configuration information of the printed material are listed and displayed in a workflow editing area 33 along the vertical direction of the order receipt creation screen 30. In addition, for the individual parts displayed as a list, icons 38 corresponding to the processes respectively set to the parts in the configuration information editing area 32 are displayed in the workflow editing area 33. In the workflow editing area 33, the person in charge edits the arrangement order of the icons 38 by rearranging the positions of the icons 38 corresponding to the respective processes, and connects the icons 38 with lines 39 to set the workflow from receiving an order for a printed material to dispatching. That is, the workflow for the printed material is represented by the arrangement order of the icons 38 along the lines 39.

The set configuration information of and the workflow for the printed material are stored in the order receipt information DB 18 when the person in charge selects an OK button 36. In contrast, when the person in charge selects a cancel button 37, the order receipt creation screen 30 is closed without storing the set configuration information of and the workflow for the printed material in the order receipt information DB 18.

Note that a mode selection checkbox 35 is displayed in the order receipt creation screen 30. When the person in charge selects the mode selection checkbox 35, a template usage mode is selected that allows the person in charge to create a workflow for a printed material using a workflow template registered in advance in the order receipt information DB18 of the process management apparatus 10. In contrast, when the person in charge does not select the mode selection checkbox 35, a template unused mode is selected that allows the person in charge to create a workflow for a printed material without using a template.

A workflow template is a template for a workflow prepared in advance by the person in charge before receiving an order for a printed material. In other words, a workflow template is a workflow created in advance by the person in charge for an order for a printed material that is expected to be ordered in the future. The template usage mode is an example of a first creation mode allowing the person in charge to create a workflow for a printed material using a template, and the template unused mode is an example of a second creation mode allowing the person in charge to create a workflow for a printed material without using a template.

The order receipt creation screen 30 illustrated in FIG. 4 is an example of a screen in the case where the template unused mode has been selected. Since no template is used in the template unused mode, every time an order for a printed material is received from a customer, the person in charge creates a workflow for the printed material from scratch in the workflow editing area 33.

In step S20 in FIG. 3, the CPU 21 determines whether the template usage mode has been selected by referring to the selection state of the mode selection checkbox 35 in the order receipt creation screen 30. When the template usage mode has not been selected, the CPU 21 switches the process from this point onward to the template unused mode, and proceeds to step S30. In contrast, when the template usage mode has been selected, the CPU 21 switches the process from this point onward to the template usage mode, and proceeds to step S90.

First, the process in the case where it is determined in the determination processing in step S20 that the template usage mode has not been selected will be described. In that case, in step S30, the CPU 21 receives an entry of configuration information and a workflow by the person in charge in the configuration information editing area 32 and the workflow editing area 33, respectively. In doing so, the configuration information of and the workflow for the printed material are created.

In step S40, the CPU 21 determines whether the OK button 36 in the order receipt creation screen 30 has been selected. When the OK button 36 has not been selected, the CPU 21 proceeds to step S30, where an entry of configuration information and a workflow by the person in charge are continuously received. In contrast, when the OK button 36 has been selected, the CPU 21 proceeds to step S50.

In step S50, the CPU 21 controls the display unit 29 and displays a confirmation dialogue 40 on the display unit 29.

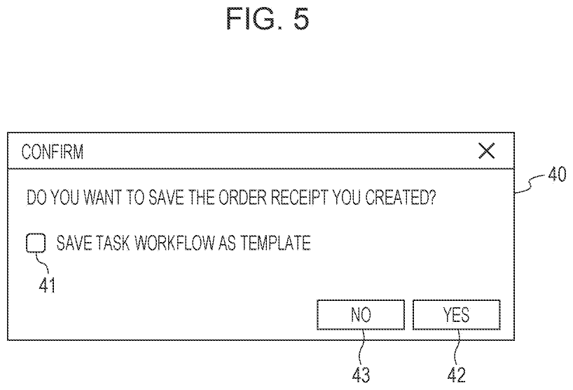

FIG. 5 is a diagram illustrating an example of the confirmation dialogue 40. The confirmation dialogue 40 is a dialogue for allowing the person in charge to select whether to register the workflow created by the person in charge in the workflow editing area 33 as a template in the order receipt information DB 18.

As illustrated in FIG. 5, the confirmation dialogue 40 includes a registration checkbox 41. When the person in charge selects the registration checkbox 41 and then selects a “yes” button 42, the workflow created by the person in charge in the workflow editing area 33 is registered as a template in the order receipt information DB 18. In contrast, when the person in charge does not select the registration checkbox 41 and then selects a “no” button 43, the workflow created by the person in charge in the workflow editing area 33 is prevented from being registered as a template in the order receipt information DB 18.

Therefore, in step S60 in FIG. 3, the CPU 21 determines whether both the registration checkbox 41 and the “yes” button 42 in the confirmation dialogue 40 have been selected, that is, whether a template registration instruction has been received from the person in charge. In this manner, by requesting the person in charge to perform two operations in the confirmation dialogue 40 when the person in charge issues a template registration instruction, an entry error of the person in charge is reduced compared to the case where a template registration instruction is issued by only one operation. In other words, using the confirmation dialogue 40, which involves two operations for registering a template, reduces the situation in which a workflow that the person in charge is not willing to register as a template is registered as a template by an operation error of the person in charge, compared to an operation method in which a template is registered by one operation.

When a template registration instruction has been received, the CPU 21 proceeds to step S70. In step S70, the CPU 21 registers the workflow created by the person in charge in the workflow editing area 33 as a template in the order receipt information DB 18, and proceeds to step S80.

Note that, if the number of registered templates exceeds an upper limit value by registering the workflow as a template in the order receipt information DB 18, the CPU 21 may display a warning message notifying the person in charge that the number of templates has reached the upper limit. Because the person in charge who confirmed the warning message reconsiders whether the workflow to be registered is a versatile workflow used as a template, the effect of reducing the number of registered templates is achieved, compared to the case where no warning message is displayed. The CPU 21 may also prohibit the registration of templates exceeding the upper limit value. In that case, when a template registered in the order receipt information DB 18 is deleted by the person in charge, a new template is permitted to be registered until the upper limit value is reached.

In contrast, in the case where it is determined in the determination processing in step S60 that no template registration instruction has been received, the CPU 21 proceeds to step S80 without executing the processing in step S70.

In step S80, the CPU 21 creates order receipt information in which the configuration information of and the workflow for the printed material, the customer information set in the customer information registration area 34, and the content of the order of the printed material are associated with one another, and stores the order receipt information in the order receipt information DB 18. Note that a product ID that uniquely identifies the ordered printed material and a product name that is the name of the printed material are added to the order receipt information. Through the above, the order receipt information creation process illustrated in FIG. 3 ends.

If the person in charge selects the “no” button 43 after selecting the registration checkbox 41 in the confirmation dialogue 40, or if the person in charge selects the “yes” button 42 without selecting the registration checkbox 41, the CPU 21 may display a dialogue for allowing the person in charge to select again.

Next, the process in the case where it is determined in the determination processing in step S20 that the template usage mode has been selected will be described.

In that case, in step S90 at the proceeding destination, the CPU 21 executes a template application process, and proceeds to step S80.

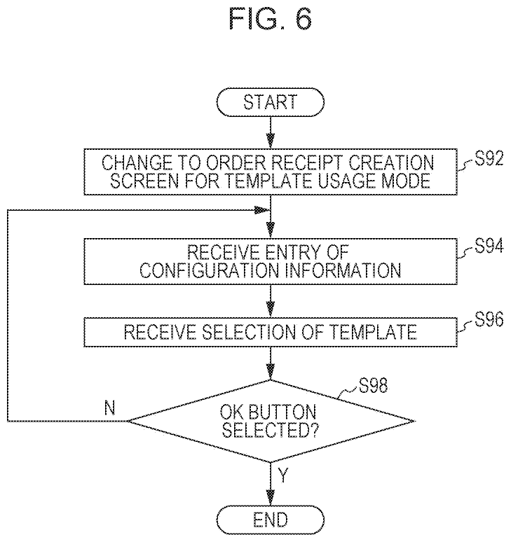

FIG. 6 is a flowchart illustrating an example of the flow of the template application process in step S90 in FIG. 3.

In step S92 in FIG. 6, the CPU 21 changes the order receipt creation screen 30 illustrated in FIG. 4 to an order receipt creation screen 30A for the template usage mode.

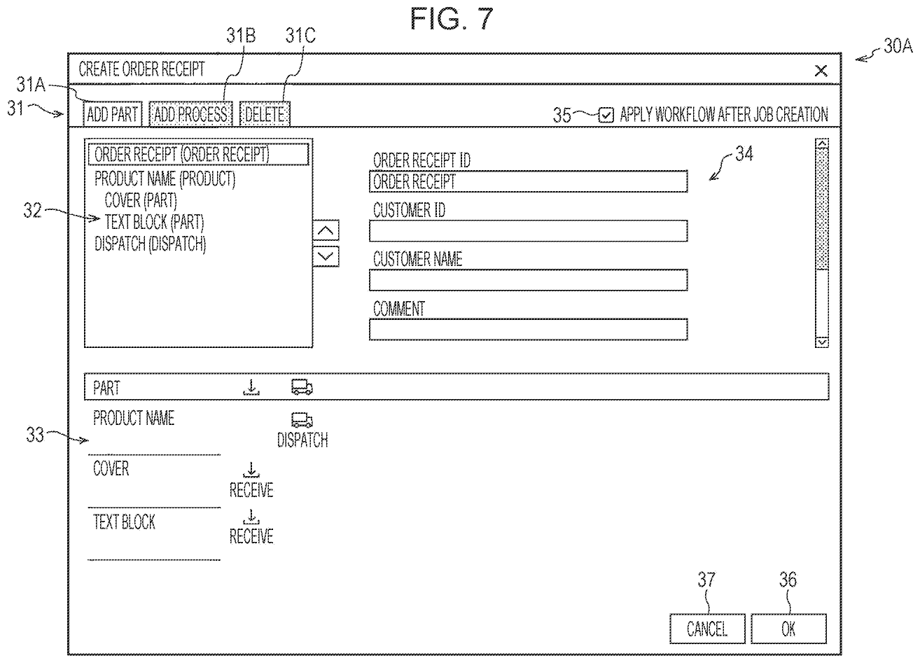

FIG. 7 is a diagram illustrating an example of the order receipt creation screen 30A for the template usage mode. The order receipt creation screen 30A is not different in its appearance from the order receipt creation screen 30 for the template unused mode illustrated in FIG. 4. However, since a template is used as a workflow for a printed material in the order receipt creation screen 30A, the workflow editing area 33 of the order receipt creation screen 30A is set to prevent the person in charge from entering or editing the workflow.

In step S94, the CPU 21 receives an entry of configuration information by the person in charge in the configuration information editing area 32. In doing so, the configuration information of the printed material is created.

In step S96, the CPU 21 displays the individual templates registered in the order receipt information DB 18 on the display unit 29 and allows the person in charge to select a template that suits the entered configuration information. In doing so, a workflow is associated with the configuration information of the printed material entered in the configuration information editing area 32.

In step S98, the CPU 21 determines whether the OK button 36 in the order receipt creation screen 30A has been selected. In the case where the OK button 36 has not been selected, the CPU 21 proceeds to step S94, where an entry of configuration information by the person in charge is continuously received. In contrast, in the case where the OK button 36 has been selected, the template application process illustrated in FIG. 6 ends, and the CPU 21 proceeds to step S80 in FIG. 3. As has been already described, in step S80 in FIG. 3, order receipt information is created in which the configuration information of and the workflow for the printed material, the customer information set in the customer information registration area 34, and the content of the order of the printed material are associated with one another, and the order receipt information is stored in the order receipt information DB 18. Through the above, the order receipt information creation process illustrated in FIG. 3 ends.

In this manner, according to the process management apparatus 10 of the present disclosure, when the person in charge selects the template unused mode in the order receipt information creation process, the person in charge is allowed to select whether to register the created workflow for the printed material as a template. Therefore, not all the workflows created in the order receipt creation screen 30 need not necessarily be registered as templates.

Note that, in the order receipt information creation process illustrated in FIG. 3, when the OK button 36 is selected to store the configuration information of and the workflow for the printed material created in the template unused mode in the order receipt information DB 18, the confirmation dialogue 40 is displayed on the display unit 29, and the person in charge is allowed to select whether to register the created workflow for the printed material as a template in the order receipt information DB 18. However, whether it is better to register the created workflow as a template is determined by considering the balance with existing templates while predicting the future order status. Performing only the creation of order receipt information in the order receipt information creation process and performing the registration of a template as a separate task is convenient in situations where it is necessary to process the order quickly and efficiently.

Therefore, the process management apparatus 10 may not display the confirmation dialogue 40 on the display unit 29 even if the OK button 36 is selected to store the configuration information of and the workflow for the printed material, which are created in the template unused mode, in the order receipt information DB 18. In that case, the workflow for the printed material created in the template unused mode is not registered as a template in the order receipt information DB 18.

In contrast, in the case where the template registration task is performed as a task separate from the order receipt information creation process, the administrator predicts the future order status of printed materials in the template registration task, and produces in advance a workflow for a printed material that is unrelated to actual orders. The purpose of such a template registration task is to register the created workflow as a template in the order receipt information DB 18. Therefore, it is preferable for the process management apparatus 10 to restrict the person in charge from selecting an option to prevent a workflow created by the person in charge from being registered as a template in the order receipt information DB 18 on a registration screen (not illustrated) where the person in charge performs the registration task.

Specifically, the registration screen corresponds to a screen for the template unused mode in which the customer information registration area 34 and the mode selection checkbox 35 have been removed from the order receipt creation screen 30 illustrated in FIG. 4. When the person in charge selects the OK button 36 provided in the registration screen, the process management apparatus 10 registers a workflow created by the person in charge as a template in the order receipt information DB 18 without displaying the confirmation dialogue 40 as illustrated in FIG. 5.

Note that a workflow for a printed material that is created in advance by the administrator in anticipation of the future order status of printed materials and that is unrelated to actual orders is an example of a workflow that is unassociated with a specific make-to-order product.

### Second Exemplary Embodiment

In the process management apparatus 10 according to the first exemplary embodiment, in the case where the template unused mode is selected in the order receipt information creation process illustrated in FIG. 3, the person in charge creates a printed material workflow from scratch in the workflow editing area 33. However, if the person in charge is a person with little experience in creating workflows, it may take a long time to create a workflow from scratch, and thus the person in charge may want to create a workflow while referring to some reference workflows.

Therefore, in the case of creating a workflow for a newly-ordered printed material in the template unused mode, the process management apparatus 10 according to the second exemplary embodiment displays a reference workflow for reference on the display unit 29 to assist the person in charge in creating the workflow.

Note that the functional configuration of the process management apparatus 10 according to the second exemplary embodiment is the same as the functional configuration example of the process management apparatus 10 according to the first embodiment illustrated in FIG. 1. In addition, the configuration of main portions of the electric system of the process management apparatus 10 according to the second exemplary embodiment is the same as the configuration example of the main portions of the electric system of the process management apparatus 10 according to the first exemplary embodiment illustrated in FIG. 2.

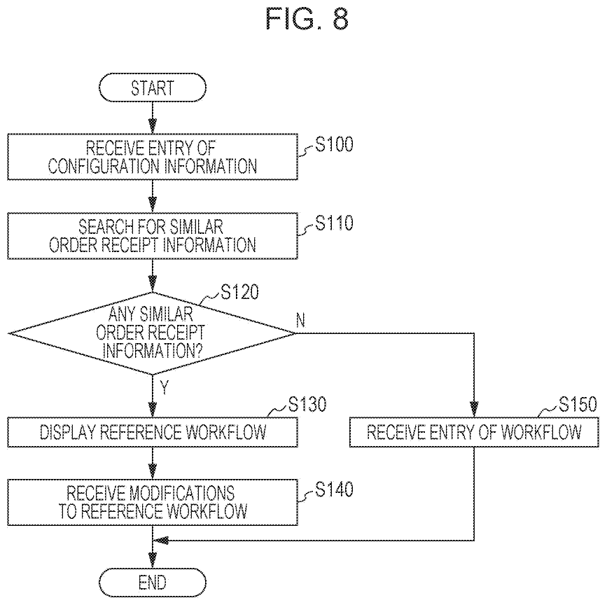

Hereinafter, the operation of the process management apparatus 10 according to the second exemplary embodiment will be described. The process management apparatus 10 executes the order receipt information creation process illustrated in FIG. 3 on receipt of a creation instruction from the person in charge to create configuration information of and a workflow for a printed material ordered from a customer. Note that step S30 in the order receipt information creation process illustrated in FIG. 3 is replaced with a support process illustrated in FIG. 8, and the order receipt information creation process is executed.

FIG. 8 is a flowchart illustrating an example of the flow of a support process executed by the CPU 21 instead of the processing in step S30 in FIG. 3 in the case where the template unused mode is selected in the order receipt information creation process according to the first exemplary embodiment illustrated in FIG. 3.

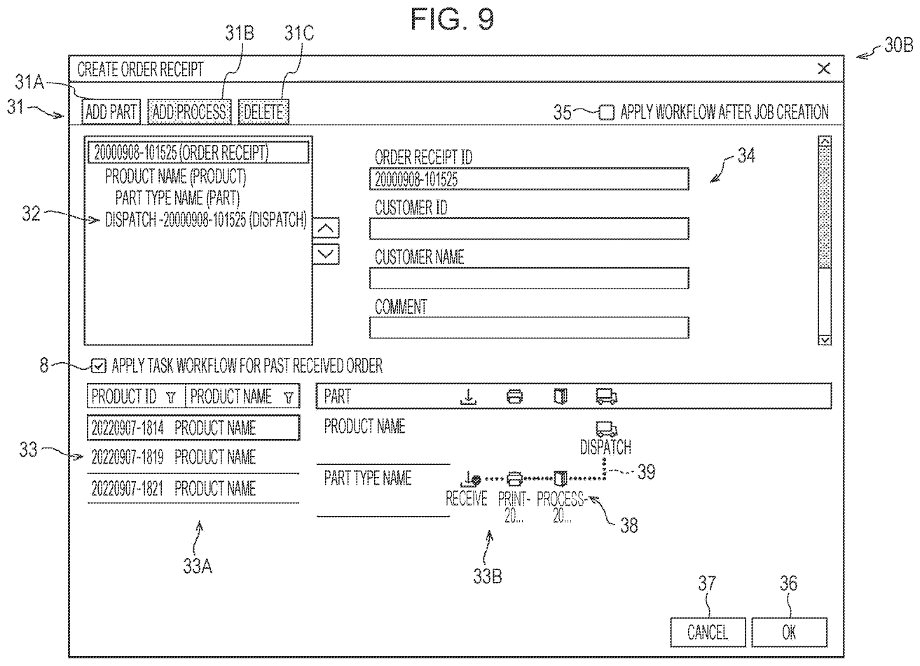

In addition, FIG. 9 is a diagram illustrating an example of an order receipt creation screen 30B displayed on the display unit 29 in the case where the template unused mode is selected in the order receipt information creation process according to the first exemplary embodiment illustrated in FIG. 3. The order receipt creation screen 30B is different from the order receipt creation screen 30 of the order receipt information creation process according to the first exemplary embodiment illustrated in FIG. 4 in the point that a support checkbox 8 is added, and the display content of the workflow editing area 33 is different. For convenience of description, the workflow editing area 33 in the order receipt creation screen 30B is divided into an order receipt information selection area 33A and a reference workflow editing area 33B.

The support checkbox 8 is an object that receives a selection from the person in charge whether to display a reference workflow on the display unit 29. In the case where the support checkbox 8 is selected, a reference workflow is displayed on the display unit 29. Here, it is assumed that the support checkbox 8 has been selected by the person in charge.

First, in step S100, the CPU 21 receives an entry of configuration information from the person in charge in the configuration information editing area 32. In doing so, the configuration information of the printed material is created.

In step S110, the CPU 21 searches the past order receipt information stored in the order receipt information DB 18 for order receipt information (referred to as “similar order receipt information”) with configuration information similar to the configuration information of the printed material entered by the person in charge in step S100. Specifically, how similar the configuration information is represented by similarity. The similarity of the configuration information is represented by a numerical value, for example, the greater the similarity, the more similar the configuration information is. In that case, for the configuration information of the printed material entered by the person in charge in step S100, the CPU 21 searches for the past order receipt information with configuration information whose similarity is greater than or equal to a predetermined threshold as similar order receipt information.

Of course, when using similarity such that the smaller the numerical value, the more similar the configuration information is, for the configuration information of the printed material entered by the person in charge in step S100, the CPU 21 may simply search for the past order receipt information with configuration information whose similarity is less than or equal to a predetermined threshold as similar order receipt information.

In the case where there is similar order receipt information, the CPU 21 displays the product ID and product name of the similar order receipt information in the order receipt information selection area 33A. Although there is no restriction on the order in which items of similar order receipt information are displayed in the order receipt information selection area 33A, it is preferable, for example, to display items of similar order receipt information sequentially in descending order of similarity in the order receipt information selection area 33A.

Note that a known similarity calculation method, such as cosine similarity, is used to calculate the similarity between items of configuration information. Meanwhile, a threshold used for determining whether the order receipt information is similar order receipt information is a value set in advance by the person in charge, and is changeable.

In step S120, the CPU 21 determines whether similar order receipt information has been found in the past order receipt information by the search processing in step S110. If similar order receipt information has been found, the CPU 21 proceeds to step S130.

When the person in charge selects any one of the items of similar order receipt information displayed in the order receipt information selection area 33A, in step S130, the CPU 21 displays a workflow associated with the selected similar order receipt information as a reference workflow in the reference workflow editing area 33B. The CPU 21 updates the display of the reference workflow in the reference workflow editing area 33B each time similar order receipt information is selected by the person in charge.

In step S140, the CPU 21 receives modifications to the reference workflow by the person in charge in the reference workflow editing area 33B. In doing so, a workflow for the printed material is created based on the reference workflow. Through the above, the support process illustrated in FIG. 8 ends, and then the CPU 21 proceeds to step S40 in FIG. 3, where the order receipt information creation process in the template unused mode is continued.

In contrast, in the case where it is determined in the determination processing in step S120 that no similar order receipt information has been found, the CPU 21 proceeds to step S150.

In that case, since there is no reference workflow for the ordered printed material, in step S150, the CPU 21 receives an entry of a workflow by the person in charge in the workflow editing area 33. In doing so, a workflow for the printed material is created, the support process illustrated in FIG. 8 ends, and then the CPU 21 proceeds to step S40 in FIG. 3, where the order receipt information creation process in the template unused mode is continued.

In some cases, it is possible that reference workflows of items of similar order receipt information searched represent the same workflow. In such a case, it is preferable not to display the overlapping reference workflow(s) in the reference workflow editing area 33B. Therefore, in the case where there are reference workflows representing the same workflow among reference workflows of similar order receipt information searched, the CPU 21 may simply display, among the reference workflows representing the same workflow, only the similar order receipt information associated with the reference workflow with the newest creation date and time in the order receipt information selection area 33A.

Although one mode of the process management system 1 has been described above using the exemplary embodiments, the disclosed form of the process management system 1 is an example, and the form of the process management system 1 is not limited to the scope described in the exemplary embodiments. Various changes or improvements may be made to the exemplary embodiments to the extent that they do not depart from the gist of the present disclosure, and the form in which such changes or improvements are made is also included in the technical scope of the disclosure. For example, the internal processing order of each of the processes illustrated in FIGS. 3, 6, and 8 may be changed to the extent that it does not depart from the gist of the present disclosure.

Furthermore, in the above-described exemplary embodiments, the form in which each of the processes illustrated in FIGS. 3, 6, and 8 is realized by software has been described as an example. However, the processing equivalent to the flowchart for each process may be processed by hardware. In that case, the processing is accelerated compared to the case where each process is realized by software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiments, an example in which the information processing program is stored in the non-volatile memory 24 has been described. However, the storage destination of the information processing program is not limited to the non-volatile memory 24. The information processing program of the present disclosure may also be provided in a format recorded on a storage medium readable by the computer 20.

For example, the information processing program may be provided in a format recorded on an optical disk, such as a compact-disk read only memory (CD-ROM) and a digital versatile disk read only memory (DVD-ROM). Alternatively, the information processing program may be provided in a format recorded in a portable semiconductor memory, such as a Universal Serial Bus (USB) memory and a memory card. The ROM 22, the non-volatile memory 24, CD-ROM, DVD-ROM, USB, and a memory card are examples of non-transitory storage media.

Furthermore, the process management apparatus 10 may download the information processing program from an external apparatus (not illustrated) connected to the communication line 3 or the communication line 5 through the communication unit 27, and store the downloaded information processing program in a storage device. In that case, the CPU 21 of the process management apparatus 10 reads the information processing program downloaded from the external apparatus from the storage device and executes the order receipt information creation process.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus including:
a processor configured to:
   switch, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.
      (((2)))

The information processing apparatus according to (((1))), wherein the processor is configured to allow the person in charge to select whether to register the workflow for the newly-ordered make-to-order product created in the second creation mode as a template.

(((3)))

The information processing apparatus according to (((2))), wherein the processor is configured to prevent the workflow for the newly-ordered make-to-order product created in the second creation mode from being registered as a template in a case where a number of already-registered templates has reached an upper limit value.

(((4)))

The information processing apparatus according to any one of (((1))) to (((3))), wherein, in a case where the person in charge has performed a registration task of pre-registering, as a template, a workflow created in advance by predicting a future order status of make-to-order products, the processor is configured to restrict the person in charge from selecting an option to prevent the created workflow from being registered as a template.

(((5)))

The information processing apparatus according to (((1))), wherein the processor is configured not to register the workflow for the newly-ordered make-to-order product created in the second creation mode as a template.

(((6)))

The information processing apparatus according to any one of (((1))) to (((5))), wherein the processor is configured to:
search for a make-to-order product with a configuration whose similarity with a configuration of the newly-ordered make-to-order product is greater than or equal to a predetermined value in the second creation mode; and
display, on a display device, a workflow for the make-to-order product searched as a reference workflow for reference when creating the workflow for the newly-ordered make-to-order product.
   (((7)))

The information processing apparatus according to (((6))), wherein, in a case where there is a plurality of reference workflows representing a same workflow, the processor is configured to display, on the display device, only a reference workflow with a new creation date and time among the plurality of reference workflows representing the same workflow.

(((8)))

The information processing apparatus according to (((7))), wherein the processor is configured to apply a workflow created by modifying the reference workflow by the person in charge as the workflow for the newly-ordered make-to-order product.

(((9)))

An information processing program causing a computer to execute a process, the process including:
switching, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.

What is claimed is:

1. An information processing apparatus comprising:
a processor configured to:
switch, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.

2. The information processing apparatus according to claim 1, wherein the processor is configured to allow the person in charge to select whether to register the workflow for the newly-ordered make-to-order product created in the second creation mode as a template.

3. The information processing apparatus according to claim 1, wherein, in a case where the person in charge has performed a registration task of pre-registering, as a template, a workflow created in advance by predicting a future order status of make-to-order products, the processor is configured to restrict the person in charge from selecting an option to prevent the created workflow from being registered as a template.

4. The information processing apparatus according to claim 2, wherein, in a case where the person in charge has performed a registration task of pre-registering, as a template, a workflow created in advance by predicting a future order status of make-to-order products, the processor is configured to restrict the person in charge from selecting an option to prevent the created workflow from being registered as a template.

5. The information processing apparatus according to claim 1, wherein the processor is configured not to register the workflow for the newly-ordered make-to-order product created in the second creation mode as a template.

6. The information processing apparatus according to claim 1, wherein the processor is configured to:
search for a make-to-order product with a configuration whose similarity with a configuration of the newly-ordered make-to-order product is greater than or equal to a predetermined value in the second creation mode; and
display, on a display device, a workflow for the make-to-order product searched as a reference workflow for reference when creating the workflow for the newly-ordered make-to-order product.

7. The information processing apparatus according to claim 6, wherein, in a case where there is a plurality of reference workflows representing a same workflow, the processor is configured to display, on the display device, only a reference workflow with a new creation date and time among the plurality of reference workflows representing the same workflow.

8. The information processing apparatus according to claim 7, wherein the processor is configured to apply a workflow created by modifying the reference workflow by the person in charge as the workflow for the newly-ordered make-to-order product.

9. A non-transitory computer readable medium storing a program causing a computer to execute a process, the process comprising:
switching, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.

10. An information processing apparatus comprising:
means for switching, in accordance with an instruction of a person in charge, between a first creation mode allowing the person in charge to create a workflow for a newly-ordered make-to-order product using a template of a pre-registered workflow among workflows representing manufacturing processes of make-to-order products with specifications that are different by customer, and a second creation mode allowing the person in charge to create the workflow for the newly-ordered make-to-order product without using the template.
